(19) United States
(12) Patent Application Publication
(10) Pub. No.: US 2008/0172266 A1
(43) Pub. Date: Jul. 17, 2008

(54) Method for automatically analyzing patent bibliographic data and apparatus thereof

(76) Inventors: Shengfu Lin, Taipei (TW); Shih Hung Lin, Taipei (TW)

Correspondence Address: BACON & THOMAS, PLLC, 625 SLATERS LANE, FOURTH FLOOR, ALEXANDRIA, VA, 22314, US

(21) Appl. No.: 11/653,416

(22) Filed: Jan. 16, 2007

(51) Int. Cl. G06Q 99/00

(52) U.S. Cl. 705/7

(57) ABSTRACT

The present invention is related to an automatic analysis method of the patent bibliographic data. One of the automatic analysis methods of the present invention is to analyze the statistical results related to the patent bibliographic data of past years, and mainly includes: functionalizing step, which makes one or more functions from one or more groups of patent bibliographic data of a special group of patents in the past; differential step, which makes one or more differential results from the one or more functions; analysis step, which analyzes the one or more differential results. The functionalizing step, differential step and analysis step are executed automatically by an automatic apparatus.

### FIELD OF THE INVENTION

The invention relates to a method for automatically analyzing patent bibliographic data and a system thereof.

### DESCRIPTION OF PRIOR ART

Although the software that employs computers for statistically investigating the patent bibliographic data are available currently, such as the statistical software from Thomson Scientific Inc. of U.S. (with the product name of Aureka), and the statistical software from Learning Tech Corp. of Taiwan (with the product name of Patent Guider), such software only allow functions related to statistical investigations, the analytical function has been absent so far. Generally, though the statistical experts dealing with patents can analyze simpler statistical diagrams related to patent bibliographic data, the more complicated statistical diagrams of patent bibliographic data are often difficult or even impossible to analyze by human alone. Moreover, there are many issues to be solved before switching from analysis by humans to automatic analysis. In this invention, the methods of smoothing, functionalizing, and differentiation are utilized, which solved the various issues that are encountered when switching from analysis by humans to automatic analysis, thereby making automatic analysis of patent bibliographic data feasible. By taking advantage of the invention, it is possible to automatically analyze the statistical results derived from the afore-mentioned Aureka or Patent Guider software, and composes a statistical report with analytical results. Furthermore, it is also possible to automatically analyze the statistical results derived from similar statistical software (including the software developed by others or on one's own); as well as the statistical results completed manually, and composing a statistical report with analytical results.

### SUMMARY OF THE INVENTION

A major objective of the invention is to provide a method for automatically analyzing patent bibliographic data.

Another objective of the invention is to provide a method for automatically analyzing patent bibliographic data, which allows patent bibliographic data to be analyzed automatically via a functionalizing step, a differential step, and an analysis step.

Another objective of the invention is to provide a method for automatically analyzing patent bibliographic data, which allows patent bibliographic data to be analyzed automatically via a smoothing step, an approximate differential step, and an analysis step.

A further objective of the invention is to provide an apparatus for automatically analyzing patent bibliographic data.

### BRIEF DESCRIPTION OF DRAWINGS

The foregoing aspects, as well as many of the attendant advantages and features of this invention will become more apparent by reference to the following detailed description, when taken in conjunction with the accompanying drawings, wherein:

FIG. 1 and FIG. 2 show flowcharts of the method according to the invention.

FIG. 3 shows the flowchart of the analysis development stages according to the invention.

FIG. 4A shows the unsmoothed total number of patents of past years according to the first embodiment of the invention.

FIG. 4B shows the smoothed total number of patents of past years according to the first embodiment of the invention.

FIG. 5A shows the unsmoothed patent life cycle according to the second embodiment of the invention.

FIG. 5B shows the smoothed patent life cycle according to the second embodiment of the invention.

### DETAILED DESCRIPTION OF PREFERRED EMBODIMENTS

A method for automatically analyzing patent bibliographic data has been disclosed in this invention, which analyzes statistical results related to patent bibliographic data of past years, comprising:

a functionalizing step, which makes one or more functions from one or more groups of statistical results related to patent bibliographic data of a special group of patents in the past;

a differential step, which makes one or more differential results from the one or more functions; and

an analysis step, which analyses the one or more differential results;

wherein the functionalizing step, differential step, and analysis step are executed automatically by an automatic apparatus.

The aforesaid statistical results related to patent bibliographic data of past years could be either completed manually or by an automatic apparatus (such as a computer), and is preferably completed by the latter method. The statistical subjects can include any known items of patent bibliographic data, like the total number of patents of past years, number of patent holders of past years, and number of inventors of past years of no particular subjects; the number of patents of past years, number of patent holders of past years, and number of inventors of past years of particular countries; the number of patents of past years, and number of inventors of past years of particular patent holders; the number of patents of past years, number of patent holders of past years, and number of inventors of past years of particular IPC (International Patent Classification); as well as the number of patents of past years, number of patent holders of past years, and number of inventors of past years of particular UPC (US Patent Classification).

Regarding to the various statistical subjects described above, it is possible to make statistical analyses aiming at a single statistical subject. For example, statistically analyzing the total number of patents of past years gives rise to statistical diagrams, tables, and/or analytical results related to total number of patents of past years; statistically analyzing the number of patents of past years in particular countries generates statistical diagrams, tables, and/or analytical results related to number of patents of past years in particular countries; statistically analyzing the number of patents of past years for particular patent holders generates statistical diagrams, tables, and/or analytical results related to number of patents of past years for particular patent holders; statistically analyzing the number of patents of past years for particular inventors generates statistical diagrams, tables, and/or analytical results related to number of patents of past years for particular inventors; statistically analyzing the number of patents of past years for particular IPC generates statistical diagrams, tables, and/or analytical results related to number of patents of past years for particular IPC; statistically analyzing the number of patents of past years for particular UPC generates statistical diagrams, tables, and/or analytical results related to number of patents of past years for particular UPC. Moreover, it is also possible to make statistical analyses aiming at multiple statistical subjects. For example, by analyzing the number of patents of past years and number of patent holders of past years, the life cycle of the total number of patents can also be analyzed. Similarly, it is possible to analyze the life cycle of patents in particular countries; the life cycle of patents for particular patent holders; the life cycle of patents for particular inventors; the life cycle of patents for particular IPC; and the life cycle of patents for particular UPC.

In the aforesaid functionalizing step, one or more functions are made from one or more groups of statistical results related to patent bibliographic data of a special group of patents in the past. Using the statistical analysis of total number of patents of past years as an example, let the number of patents in the 1^{st}, 2^{nd}, 3^{rd} . . . and mth year be N₁, N₂, N₃ . . . and Nₘ, and let N, which is the number of patents of past years; be the function F(t) of time (year), as shown below:

N=F(t) (1)

In this example, the function F(t) can be defined as the formula below:

F(t)=a₀+a₁t+a₂t²+a₃t³+ (2)

In formula (2), a₀ is a constant, and a₁, a₂, a₃ . . . are respectively the coefficient that represent power 1, 2, 3 . . . in the exponentiation (t¹, t², t³ . . . ) of variable t. Optimal values can be obtained from the above-mentioned values a₀, a₁, a₂, a₃ . . . by using the method of root mean square (RMS) in combination with partial differential technique; the optimization of coefficients was previously known, and can be briefly described as follows: the difference between the value of function (F(tⱼ)) and the actual value (Nⱼ) of different years (tⱼ) is F(tⱼ)−Nⱼ, and the resulted sum after squaring the difference for each year is: Σ(F(tⱼ)−Nⱼ)², which means the root mean square (RMS) of the difference for each year is:

RMS=(Σ(F(tⱼ)−Nⱼ)²)^{1/2}

Let the partial differential value of RMS to a₀, a₁, a₂, a₃ . . . aₙ be 0, and then n+1 number of simultaneous equations can be obtained. After solving the n+1 number of simultaneous equations, n+1 number of coefficients of a₀, a₁, a₂, a₃ . . . aₙ can be obtained.

In the example of statistical diagrams showing the life cycle of patents, the horizontal axis represents the number of patent holders; the vertical axis represents the number of patents. However, there is no certain relationship between the number of patents at the vertical axis and the number of patent holders at the horizontal axis, which means there is no functional relationship between the two, and thus it presents a major problem when making automatic statistical analysis. In response to this particular problem, the inventor has come up with a solution, which defines the number of patent holders N1 represented by horizontal axis, and the number of patents M1 represented by vertical axis as functions of time (t), as indicated below separately:

N₁=F₁(t) (3)

M₁=F₂(t) (4)

Subsequently, the functions F₁(t) and F₂(t) are analyzed respectively, and an example is given in the differential analysis described below.

In the differential step, first order differentiation and/or second order differentiation are made from the one or more functions. Using the analysis of statistical diagrams for the number of patents of past years as an example, making first order differentiation gives the slope of functions at some particular points, which is the annual rate of increase for the number of patents at each of the particular point. Furthermore, making second order differentiation gives the second order differential value of functions at some particular points, which is the basis for determining inflection points.

According to formula (2), those skilled in the technique of differentiation should know that:

d F(t)/dt=a₁+2a₂t+3a₃t²+ (3)

d²F(t)/dt²=2a₂+6a₃t + (4)

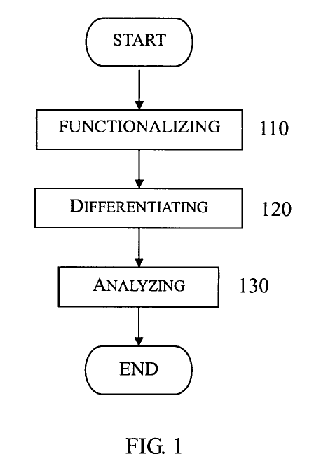

If coefficients a₁, a₂, a₃ . . . are decided in advance according to the aforesaid method, the values derived from formulas (3) and (4) are generally reasonable. FIG. 1 shows the steps in the execution of this method. In FIG. 1, numbers 110, 120, and 130 represent the functionalizing step, differential step, and analysis step respectively.

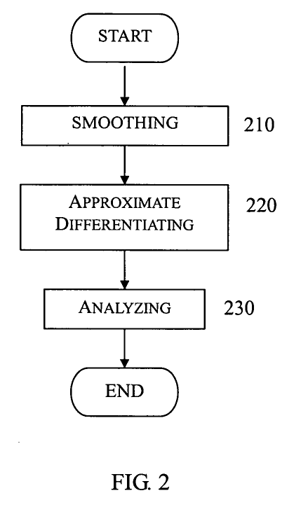

However, the aforesaid method involves complex calculations, and thus the technique of smoothing is combined with differential approximation in order to achieve simplification of the method, and the simplified method can be described as follows. FIG. 2 shows the steps in the execution of this method. In FIG. 2, numbers 210, 220, and 230 represent the smoothing step, approximate differential step, and analysis step, respectively.

Those skilled in the techniques of calculus should know that; to two points that are not far apart from one another, the first order approximate differential value thereof is:

d F(t)/dt≈(F(t₂)−F(t₁))/(t₂−t₁)

If a period of two years is set as the interval between the two points, which means t₂−t₁=1, that is:

d F(t)/dt≈F(t₂)−F(t₁) (5)

Basing on the same principle, the second order approximate differential value thereof is:

d²F(t)/dt²≈((F(t₃)−F(t₂))−(F(t₂)−F(t₁))/(t₃−t₂)

If a period of three years is set as the interval between the three points, which means t₃−t₂=t₂−t₁=1, that is:

d²F(t)/dt²≈F(t₃)+F(t₁)−2F(t₂) (6)

But if not properly handled, the approximate differential values of formulas (5) and (6) often deviate from reasonable values. In response to this problem, it has been found that if raw statistical value is smoothed on a multi-year basis, the approximate differential values of formulas (5) and (6) would fall within the range of reasonable values, and the curves from the diagrams derived from the values would be reasonably smooth, as shown in the first embodiment. The number of year used for smoothing is ideally between 3 to 10 years, and preferably to be between 5 to 7 years. Using the smoothing based on a 5-year period as an example, the smoothed value of the first year is directly obtained from the original value of the first year; the smoothed value of the second year is obtained from the average of original values from the first and the second years; the smoothed value of the third year is obtained from the average of original values from the first to the third years; the smoothed value of the fourth year is obtained from the average of original values from the first to the fourth years; the smoothed value of the fifth year is obtained from the average of original values from the first to the fifth years; the smoothed value of the sixth year is obtained from the average of original values from the second to the sixth years; the smoothed value of the seventh year is obtained from the average of original values from the third to the seventh years . . . and so on. In other words, the smoothed value of the m^{th} year can be described in the mathematical formula shown below:

$$\begin{matrix}{N}_{m} = ( {\sum }_{i = 1}^{m} {N}_{i} ) / m & ( 7 ) \\ {N}_{m} = ( {\sum }_{i = m - 4}^{m} {N}_{i} ) / m & ( 8 )\end{matrix}$$

Formula (7) is preferably applied to the first and the fourth year, and formula (8) is preferably applied to the fifth year and the years hereafter. The Nₘ in the formulas is the smoothed value of the mth year of a particular subject from the statistical results related to patent bibliographic data of past years.

As for the differential methods that have multiple groups of functions, first order differentiation and/or second order differentiation are made from each of the functions separately. Using the diagram of life cycle as the example, the functionalizing step sorts out two groups of functions as described above, which are F₁(t) and F₂(t). Using the aforesaid methods to find the coefficient of the function F₁(t), the following can be obtained:

F₁(t)=a₀₁+a₁₁t+a₂₁t²+a₃₁t³+ (9)

Making first order differentiation and/or second order differentiation from F₁(t) gives:

d F₁(t)/dt=a₁₁+2a₂₁t+3a₃₁t²+ (10)

d²F₁(t)/dt²=2a₂₁+6a₃₁t+ (11)

Similarly, the coefficient of the function F₂(t) can be found out by using the aforesaid method, and gives rise to:

F₂(t)=a₀₂+a₁₂t+a₂₂t²+a₃₂t³+ (12)

Making first order differentiation and/or second order differentiation from F₂(t) gives:

d F₂(t)/dt=a₁₂+2a₂₂t+3a₃₂t²+ (13)

d² F₂(t)/dt²=2a₂₂+6a₃₂t+ (14)

After smoothing, if approximate differential value is to be derived from the formulas, then:

d F₁(t)/dt≈F₁(t₂)−F₁(t₁) (15)

d² F₁(t)/dt²≈F(t₃)+F₁(t₁)−2F₁(t₂) (16)

d F₂(t)/dt≈F₂(t₂)−F₂(t₁) (17)

d² F₂(t)/dt²≈F₂(t₃)+F₂(t₁)−2F₂(t₂) (18)

In the aforesaid analysis step, analysis of the one or more differential results is undertaken. The analysis is completed by using values that are set in advance (preferably in tabulation) and/or analysis flowchart set in advance as the basis, and is preferably combined with original statistical results. Other types of analysis method can also be employed, such as using point-to-point distance along with the analysis of point-to-point slope. However, it is more preferable to analyze by the aforesaid tabulation method or flowchart method, with the combination of the tabulation method and the flowchart method being the most preferable option. In the following example, analyses of statistical diagrams for number of patents from past years, and life cycle of patents are described:

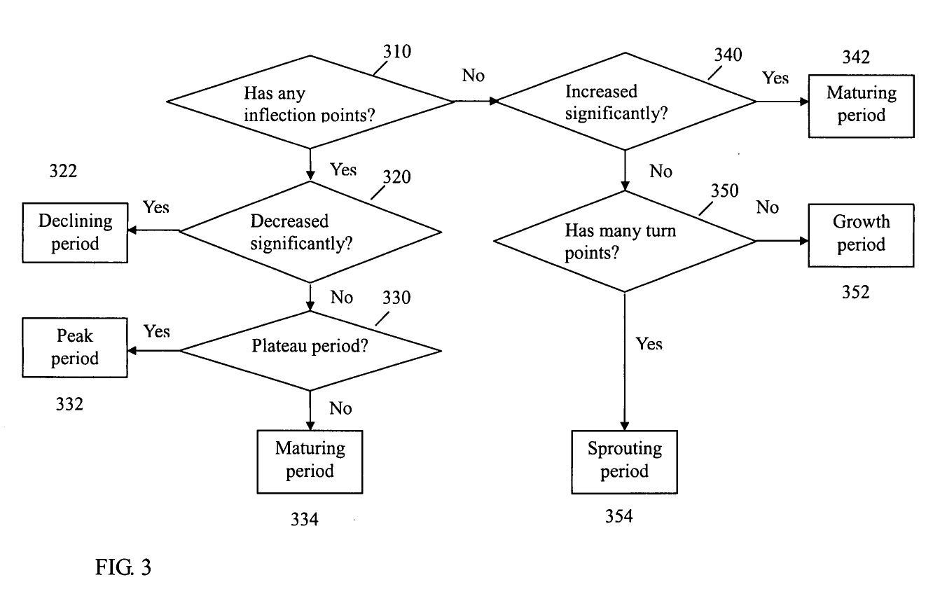

The analysis of statistical results for number of patents from past years can be achieved by using tabulation method or flowchart method. The following description is based on the flowchart method. As shown in FIG. 3, in which step 310 uses a table or diagram to determine if the table or diagram contain any inflection points (the first order differential value is large, and the second order differential value is 0 or changed from a large positive value to a large negative value); if the result from the step 310 is yes, the step 320 is carried out next; if not, the step 340 is carried out instead. In the step 320, if the first order differential value after the inflection point is obviously negative in consecutive, it can be determined that the number of patents after the inflection point has decreased significantly (which can also be determined directly from the original statistical results or smoothed statistical results, or determined by using the combination of one of the two results with the differential values, and the latter is preferred). That is it continues to the step 322, i.e. a declining period. If it is “No” from the step 320, step 330 is carried out. In the step 330, the first order differential values after the inflection point are observed to see whether they are all 0 or their absolute values approximately equal to 0, after which it is determined whether the trend after the inflection point is at the plateau period; if it is (which means there is no big change in the number of patents), it leads to the step 334 and determines a peak period is present; if it is not, it leads to the step 332 and determines a maturing period is shown. In the step 340, if the first order differential value after the inflection point is apparently positive in consecutive, it can be determined that the number of patents after the inflection point has increased significantly; if it is, it continues to the step 342 and determines a maturing period is present, otherwise the step 350 is carried out instead. In the step 350, the first order differential values after the inflection point are observed to see if there are many positive and negative values interspersing between each other; if it is, it continues to the step 354 and determines a sprouting period is present; if it is not, it continues to the step 352 and determines a growth period is present instead. The determination of the aforesaid inflection points is accomplished by using the actual differential values; if approximate differential values are utilized, the resulting first order approximate differential values would be quite large, but if the second order differential values changed from large positive values to large negative values suddenly, the presence of inflection points can be determined.

The analysis of statistical results of the life cycle of patents can be achieved by using tabulation method and flowchart method. The following description is based on the tabulation method: for instance, by utilizing the changes in the number of patent applicants of past years and in the total number of patents of past years shown in Table 1, it is possible to deduce a sprouting period, growth period, maturing period, peak period, or declining period at the current life cycle.

TABLE 1

| | Number of patent holders from the past | | | Number of patents from the past | | |
|---|---|---|---|---|---|---|
| | First Order | Second Order | Number of patent | First Order | Second Order | Number of |
| | Differentiation | Differentiation | holders | Differentiation | Differentiation | patents |
| Sprouting | Fluctuation between | Fluctuation | Very few–few | Fluctuation | Fluctuation | Very few–few |
| period | positive and negative | between positive | | between positive | between positive | |
| | values | and negative | | and negative | and negative | |
| | | values | | values | values | |
| Growth | Positive value | Positive value | Small | Positive value | Positive value | Small |
| period | (small–medium–large) | | increase–increase | (small–medium) | (small) | increase–increase |
| Maturing | Positive–zero–small | Contains | Increase–small | Positive value | Contains | Increase–large |
| period | negative | unpronounced | increase–small | (large) | inflection point(s) | increase |
| | | inflection point(s) | decrease | | | |
| Peak | Small negative | Fluctuation | Small decrease | Small | Negative value | Large amount |
| period | | between positive | | positive–zero–small | | with increase |
| | | and negative | | negative | | and decrease |
| | | values | | | | of small |
| | | | | | | magnitude |
| Declining | Negative value | Negative value | Large or long | Negative value | Negative value | Large or long |
| period | | | decrease | | | decrease |

*** The “–” symbol in Table 1 indicates a trend from . . . to . . . For example, “Small–Medium–Large” means the trend is going from small to medium, and to large eventually.

The analysis of the aforesaid developmental stages (sprouting period, growth period, maturing period, peak period, or declining period) has further made the analysis of risks and technology trend possible.

The aforementioned automatic apparatus can be any automatic apparatuses of prior art; such as computers, or automatic apparatuses that were specifically designed to suit the purpose of the invention, or any automatic apparatuses with similar functions, and is preferably computers. The computers mentioned here is meant to cover computers in general, including desktop computers, laptop computers, and PDAs, and is preferably desktop computers or laptop computers. The automatic apparatuses that were specifically designed to suit the purpose of the invention mentioned here, can be composed of microprocessors, input and output devices, and input and output interfaces; if necessary, additional memories can be added into it. The input and output devices include hard disk, CD-ROM, visual display, keyboard, mouse, or other types of devices; such as a keypad. The input and output interfaces can include wireless input and output interfaces (such as RF input and output interface or infra-red input and output interface), or input and output interfaces linked via cords, such as the traditional buses; whereas memories can be either ROM (Read Only Memory) and/or RAM (Random Access Memory). The automatic apparatuses with similar functions mentioned here refers to the ones that are similar to computers (such as functionally simplified computers), or the automatic apparatuses that were not specifically designed to suit the purpose of the invention, but equipped with similar functions and/or composition.

The smoothing step shown in FIG. 2 can be seen as a substitute for the functionalizing step in the aforesaid method, as well as the smoothing of the functional curves derived from functionalizing. This is because calculations involved in the smoothing step actually contain the functionalizing step.

The invention also discloses an apparatus for automatically analyzing patent bibliographic data, comprising:

an automatic apparatus; and

a patent bibliographic data analysis software, which allows the automatic apparatus to analyze the patent bibliographic data;

wherein steps executed in the analysis software comprising:

a functionalizing step, which makes one or more functions from one or more groups of statistical results related to patent bibliographic data of a special group of patents in the past;

a differential step, which makes one or more differential results from the one or more functions; and

an analysis step, which analyses the one or more differential results.

The aforesaid analysis software is automatically executed in conjucntion with the automatic apparatus.

As described previously, the aforesaid automatic apparatus is preferably a computer.

The aforesaid patent bibliographic data analysis software can be stored outside of the computer independently (such as in portable hard disks, floppy disks, compact discs, or networks, which includes intranet and internet), and loaded when the analysis of patent bibliographic data is to be done. The patent bibliographic data analysis software can be stored inside of the computer, such as in the ROM or built-in hard disks of the computer.

The functionalizing step, differential step, and analysis step mentioned above are as described previously.

The invention can be further elucidated by the exemplary embodiments given below; however, the scope of the invention is not limited to the embodiments.

### First Embodiment

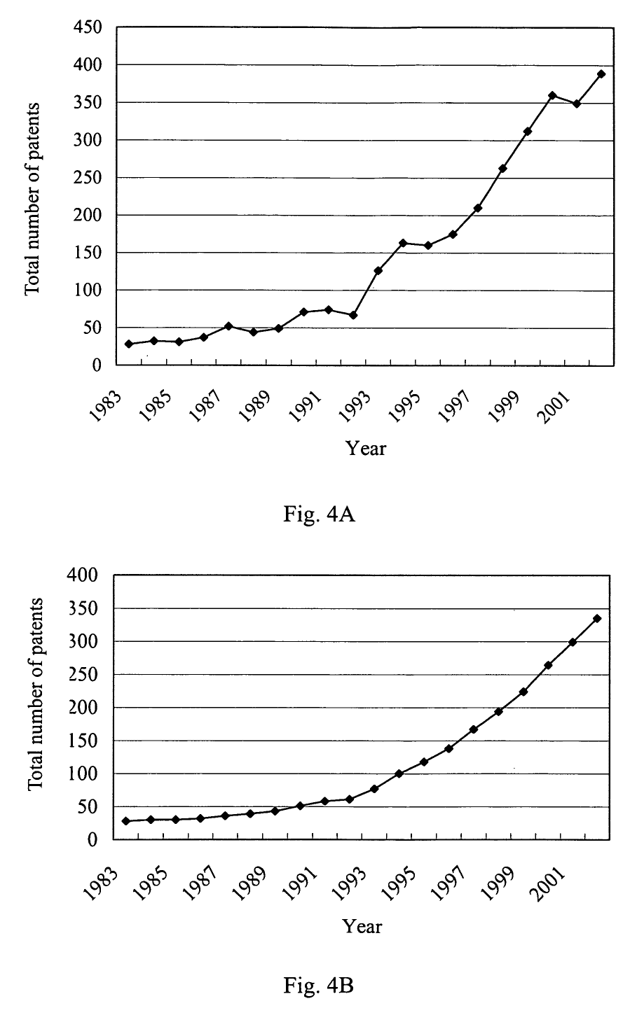

Using the Patentsearch disc from Micropatent to carry out searching in the period between 1983 to 2002; the aim of searching was to find the patents with the word “RFID” in its abstract or title, the search result returned a total of 2992 entries of patents. After statistically studying the total number of patents of past years, it gave rise to a first column (the column of year) and a second column (the column of unsmoothed number of patents) as indicated in Table 2; the computer then smoothed the value of the second column on a 5-year basis, which subsequently generating a third column (the column of smoothed number of patents) indicated in Table 2. The computer automatically drew diagrams by using the values in the first and the second columns, and thus obtaining FIG. 4A; while the computer automatically drew diagrams by using the values in the first and the third columns, and thus obtaining FIG. 4B. The comparison of FIG. 4A and FIG. 4B showed that the curve in FIG. 4B is obviously much smoother than that of FIG. 4A.

In the table, the first (year 1983), second (year 1984), third (year 1985), and fourth value (year 1986) of the third column each represents the mean value of number of patents per year from 1983 onwards (numbers after the decimal point are rounded up in order to give an integer). For the fifth year (1987) and years thereafter, a 5-year mean value is obtained by using the numbers of patents of the 4 years preceding a specific year, and of the specific year itself (numbers after the decimal point are rounded up in order to give an integer), for instance:

1983 28=28/1

1984 30=(28+32)/2

1985 30=(28+32+31)/3

1986 32=(28+32+31+37)/4

1987 36=(28+32+31+37+52)/5

1988 39=(32+31+37+52+44)/5

TABLE 2

| | Unsmoothed | After smoothing | | |
|---|---|---|---|---|
| | Number of | Number of | First Order | Second Order |
| Year | patents | patents | Differentiation | Differentiation |
| 1983 | 28 | 28 | | |
| 1984 | 32 | 30 | 2 | |
| 1985 | 31 | 30 | 0 | −2 |
| 1986 | 37 | 32 | 2 | 0 |
| 1987 | 52 | 36 | 4 | 4 |
| 1988 | 44 | 39 | 3 | −1 |
| 1989 | 49 | 43 | 4 | 1 |
| 1990 | 71 | 51 | 8 | 4 |
| 1991 | 74 | 58 | 7 | −1 |
| 1992 | 67 | 61 | 3 | −4 |
| 1993 | 126 | 77 | 16 | 13 |
| 1994 | 163 | 100 | 33 | 20 |
| 1995 | 160 | 118 | 18 | −15 |
| 1996 | 175 | 138 | 20 | 2 |
| 1997 | 210 | 167 | 29 | 9 |
| 1998 | 263 | 194 | 27 | −2 |
| 1999 | 312 | 224 | 30 | 3 |
| 2000 | 360 | 264 | 40 | 10 |
| 2001 | 349 | 299 | 35 | −5 |
| 2002 | 389 | 335 | 36 | 1 |

The computer automatically carried out the approximate differential step, consequently obtaining the values in the fourth and the fifth columns of Table 2. By following the steps shown in FIG. 3, FIG. 4B and its corresponding values are analyzed; from the second order approximate differential values, it was discovered that: the second order approximate differential value of the year 1994 was the maximum positive value (20), while the value for the year 1995 decreased to −15, the minimum value, and this means the curve would pass through point zero between the two years. Therefore, it could be determined that there was an inflection point between the year 1994 and the year 1995. The first order approximate differential values between 1993-1996 were quite large, it can serve as a secondary proof for the presence of the inflection point between 1994 and 1995. After the step 310 of FIG. 3, the process was continued to further examine if there was any significant decrease in the number of patents afterwards (the step 320), and since the first order approximate differential values between 1995-2002 were large positive values, it was determined there was no significant decrease in the number of patents. Subsequently, it was followed by the execution of the step 330, which determined the plateau period was absent. As a result, the process proceeded to the step 334 and concluded the technology in question is at the maturing period currently.

### Second Embodiment

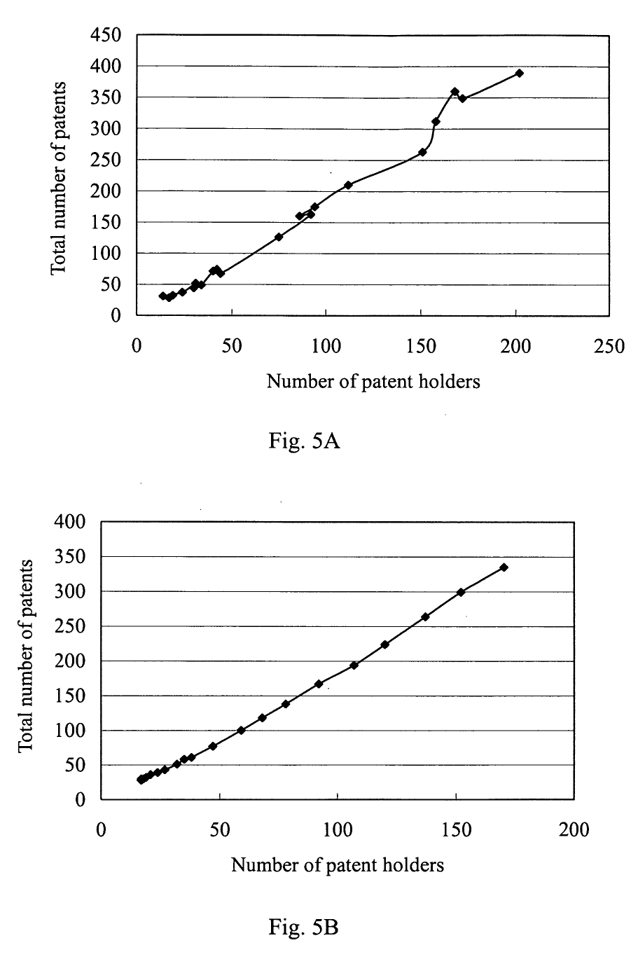

The patents described in First Embodiment were investigated in order to make life cycle statistical results, and a first column (the column of year), a second column (the column of number of patent holders), and a third column (the column of number of patents) indicated in Table 3 were obtained. The computer then automatically smoothed the values of the second and the third columns on a 5-year basis, which subsequently generating a fourth column (the column of number of patent holders after smoothing), and a fifth column (the column of number of patents after smoothing) indicated in Table 3. The computer automatically used the values from the second and the third columns to draw a X-Y distribution diagram, thereby obtaining FIG. 5A; it also automatically used the values from the fourth and the fifth columns to draw a X-Y distribution diagram, thereby obtaining FIG. 5B.

By using the afore-mentioned tabulation method, the computer automatically analyzed FIG. 5B and its corresponding values (the values from the fourth and the fifth columns in Table 3), subsequently obtaining Table 4.

TABLE 3

| | | | Number of Patent | Number |
|---|---|---|---|---|
| | Number of | Number of | Holders After | of Patents |
| Year | Patent Holders | Patents | Smoothing | After Smoothing |
| 1983 | 17 | 28 | 17 | 28 |
| 1984 | 19 | 32 | 18 | 30 |
| 1985 | 14 | 31 | 17 | 30 |
| 1986 | 24 | 37 | 19 | 32 |
| 1987 | 31 | 52 | 21 | 36 |
| 1988 | 30 | 44 | 24 | 39 |
| 1989 | 34 | 49 | 27 | 43 |
| 1990 | 40 | 71 | 32 | 51 |
| 1991 | 42 | 74 | 35 | 58 |
| 1992 | 44 | 67 | 38 | 61 |
| 1993 | 75 | 126 | 47 | 77 |
| 1994 | 92 | 163 | 59 | 100 |
| 1995 | 86 | 160 | 68 | 118 |
| 1996 | 94 | 175 | 78 | 138 |
| 1997 | 112 | 210 | 92 | 167 |
| 1998 | 151 | 263 | 107 | 194 |
| 1999 | 158 | 312 | 120 | 224 |
| 2000 | 168 | 360 | 137 | 264 |
| 2001 | 172 | 349 | 152 | 299 |
| 2002 | 202 | 389 | 170 | 335 |

TABLE 4

| | Number of Patent Holders After | | | | | |
|---|---|---|---|---|---|---|
| | Smoothing | | | Number of Patents After Smoothing | | |
| | | First order | Second order | | First order | Second order |
| | Number | approximate | approximate | | approximate | approximate |
| | of patent | differential | differential | Number of | differential | differential |
| | holders | value | value | patents | value | value |
| 1983 | 17 | | | 28 | | |
| 1984 | 18 | 1 | | 30 | 2 | |
| 1985 | 17 | −1 | −2 | 30 | 0 | −2 |
| 1986 | 19 | 2 | 3 | 32 | 2 | 0 |
| 1987 | 21 | 2 | 0 | 36 | 4 | 4 |
| 1988 | 24 | 3 | 1 | 39 | 3 | −1 |
| 1989 | 27 | 3 | 0 | 43 | 4 | 1 |
| 1990 | 32 | 5 | 2 | 51 | 8 | 4 |
| 1991 | 35 | 3 | −2 | 58 | 7 | −1 |
| 1992 | 38 | 3 | 0 | 61 | 3 | −4 |
| 1993 | 47 | 9 | 6 | 77 | 16 | 13 |
| 1994 | 59 | 12 | 3 | 100 | 33 | 20 |
| 1995 | 68 | 9 | −3 | 118 | 18 | −15 |
| 1996 | 78 | 10 | 1 | 138 | 20 | 2 |
| 1997 | 92 | 14 | 4 | 167 | 29 | 9 |
| 1998 | 107 | 15 | 1 | 194 | 27 | −2 |
| 1999 | 120 | 13 | −2 | 224 | 30 | 3 |
| 2000 | 137 | 17 | 4 | 264 | 40 | 10 |
| 2001 | 152 | 15 | −2 | 299 | 35 | −5 |
| 2002 | 170 | 18 | 3 | 335 | 36 | 1 |

By using the results from the second, the third, the fourth, the fifth, the sixth, and the seventh columns of Table 4, the computer generated a Table 5.

TABLE 5

| Number of Patent Holders of Past years | | | | | |
|---|---|---|---|---|---|
| | | Number | Number of Patents of Past years | | |
| First order | Second order | of patent | First order | Second order | Number of |
| differentiation | differentiation | holders | differentiation | differentiation | patents |
| Positive | Contains | Increase | Positive | Contains | Increase |
| | unpronounced | | (large) | inflection | significantly |
| | inflection | | | point(s) | |
| | point(s) | | | | |

After comparing the results of Table 5 with that of Table 1, it was determined the RFID technology is at the growth period.

1. A method for automatically analyzing patent bibliographic data, which analyzes statistical results related to patent bibliographic data of past years, comprising:
a functionalizing step, which makes one or more functions from one or more groups of statistical results related to patent bibliographic data of a special group of patents in the past years;
a differential step, which makes one or more differential results from the one or more functions; and
an analysis step, which analyzes the one or more differential results;
wherein the functionalizing step, differential step, and analysis step are executed automatically by an automatic apparatus.

2. The method of claim 1, wherein the differential step makes first order differentiation and second order differentiation from the one or more functions.

3. The method of claim 2, wherein the analysis step analyzes the differential results in combination with the statistical results.

4. The method of claim 3, wherein the analysis step is carried out by using comparison of tabulation, and/or comparison of flowchart in sequence.

5. The method of claim 1, wherein the automatic apparatus is a computer.

6. A method for automatically analyzing patent bibliographic data, which analyzes statistical results related to patent bibliographic data of past years, comprising:
a smoothing step, which makes one or more smoothed results from one or more groups of statistical results related to patent bibliographic data of a special group of patents in the past years;
an approximate differential step, which makes one or more approximate differential results from the one or more smoothed results; and
an analysis step, which analyzes the one or more approximate differential results;
wherein the smoothing step, approximate differential step, and analysis step are executed automatically by an automatic apparatus.

7. The method of claim 6, wherein the smoothing step smoothes the one or more groups of statistical results related to patent bibliographic data of the past years on a five-year to seven-year basis.

8. The method of claim 7, wherein the approximate differential step makes first order approximate differentiation and second order approximate differentiation from the one or more smoothed results.

9. The method of claim 7, wherein the analysis step analyzes the approximate differential results in combination with the statistical results.

10. The method of claim 9, wherein the analysis is carried out by using comparison of tabulation, and/or comparison of flowchart in sequence.

11. The method of claim 6, wherein the automatic apparatus is a computer.

12. An apparatus for automatically analyzing patent bibliographic data, comprising:
an automatic apparatus; and
a patent bibliographic data analysis software, which allows the automatic apparatus to analyze the patent bibliographic data;
wherein steps executed in the analysis software comprising:
a functionalizing step, which makes one or more functions from one or more groups of statistical results related to patent bibliographic data of a special group of patents in past years;
a differential step, which makes one or more differential results from the one or more functions; and
an analysis step, which analyzes the one or more differential results.

13. The apparatus of claim 12, wherein the differential step makes first order differentiation and second order differentiation from the one or more functions.

14. The apparatus of claim 13, wherein the analysis step analyzes the differential results in combination with the statistical results.

15. The apparatus of claim 14, wherein the analysis is carried out by using comparison of tabulation, and/or comparison of flowchart in sequence.

16. The apparatus of claim 12, wherein the automatic apparatus is a computer.

17. An apparatus for automatically analyzing patent bibliographic data, comprising:
an automatic apparatus; and
a patent bibliographic data analysis software, which allows the automatic apparatus to analyze the patent bibliographic data;
wherein steps executed in the analysis software comprising:
a smoothing step, which makes one or more smoothed results from one or more groups of statistical results related to patent bibliographic data of a special group of patents in past years;
an approximate differential step, which makes one or more approximate differential results from the one or more smoothed results; and
an analysis step, which analyzes the one or more approximate differential results.

18. The apparatus of claim 17, wherein the smoothing step smoothes the one or more groups of statistical results related to patent bibliographic data of the past years on a five-year to seven-year basis.

19. The apparatus of claim 17, wherein the approximate differential step makes first order approximate differentiation and second order approximate differentiation from the one or more smoothed results.

20. The apparatus of claim 19, wherein the analysis step analyzes the approximate differential results in combination with the statistical results.

21. The apparatus of claim 20, wherein the analysis is carried out by using comparison of tabulation, and/or comparison of flowchart in sequence.

22. The apparatus of claim 17, wherein the automatic apparatus is a computer.
